(19) United States
(12) Patent Application Publication
(10) Pub. No.: US 2025/0319651 A1
(43) Pub. Date: Oct. 16, 2025

(54) THREE-DIMENSIONAL SHAPED OBJECT, MANUFACTURING METHOD THEREOF, AND TREATMENT LIQUID

(71) Applicant: CANON KABUSHIKI KAISHA, Tokyo (JP)

(72) Inventors: KENICHI KANAI, Chiba (JP); TAKUYA SHIMIZU, Kanagawa (JP); EMI OISHI, Kanagawa (JP)

(21) Appl. No.: 19/173,180

(22) Filed: Apr. 8, 2025

(30) Foreign Application Priority Data
Apr. 10, 2024 (JP) 2024-063108

(51) Int. Cl. B29C 64/124; B29C 71/00; B29K 105/00; B29L 9/00; B33Y 10/00; B33Y 40/20; C08K 3/04; C08K 5/524; C08K 5/5397

(52) U.S. Cl. CPC B29C 64/124; B29C 71/0009; B33Y 10/00; B33Y 40/20; C08K 3/04; C08K 5/524; C08K 5/5397; B29K 2105/0002; B29L 2009/005; C08K 2201/005

(57) ABSTRACT

There is provided a three-dimensional shaped object formed of a resin containing inorganic particles with improved external appearance quality by effectively removing an uncured photocurable resin composition in the three-dimensional shaped object. A three-dimensional shaped object includes a layered portion obtained by layering a plurality of resin layers, wherein the three-dimensional shaped object contains a number of inorganic particles, wherein a plurality of inorganic particles among the number of inorganic particles is dispersed into the layered portion, and wherein a layered and shaped surface shaped by each of the plurality of resin layers in the layered portion includes a projection formed of a resin film covering some of the number of inorganic particles, the projection corresponding to a shape of the some of the number of inorganic particles.

### BACKGROUND

### Field of the Technology

The present disclosure relates to a three-dimensional shaped object to be cured using an activation energy beam, a manufacturing method of the three-dimensional shaped object, and a treatment liquid for use in the manufacturing method.

### Description of the Related Art

In recent years, against the background of diversification of shaping materials and evolution of equipment technology, three-dimensional layering shaping (Additive Manufacturing (AM)) has been increasingly used as a means of manufacturing products. The AM methods include shaping methods called vat photopolymerization and stereolithography. In such shaping methods, a liquid photopolymerizable compound is cured by a light-emitting device (LED) light, a laser light source, or a projector to form a three-dimensional shape. These methods enable high-precision and high-accuracy shaping.

In stereolithography, when an optically shaped object is taken out of a shaping tank filled with a photocurable resin composition including a photopolymerizable compound after completion of shaping, an uncured photocurable resin composition remains on the surface of the optically shaped object. The uncured photocurable resin composition has a curved surface formed by surface tension and adheres to the surface of the optically shaped object. When post-curing is performed, the uncured photocurable resin composition is cured, which may cause unevenness of light reflection. Therefore, in the related art, the optically shaped object is washed with a treatment liquid to remove the uncured photocurable resin composition. However, in this case, it has been difficult to completely remove the uncured photocurable resin composition adhering to concave portions and convex portions on the surface of the optically shaped object or adhering to deeper portions or corner portions of the concave portions and convex portions.

Japanese Patent Application Laid-Open No. H05-318605 discusses a method for reliably and simply removing an uncured photocurable resin composition adhering to an optically shaped object by injecting resin particles onto the surface of the optically shaped object, and also discusses a method for melting resin particles digging into the surface of the optically shaped object by injection, thereby forming a resin coating.

In a case where an optically shaped object contains inorganic particles, when an uncured photocurable resin composition adhering to the surface of the optically shaped object is completed removed, the inorganic particles are exposed from the surface of the optically shaped object. In this case, color unevenness occurs due to a difference between the color of inorganic particles and the color of the cured photocurable resin composition other than the inorganic particles. This impairs the external appearance quality of the shaped object and this makes it difficult to determine whether a flaw or a shaping failure has occurred, based on the external appearance. Even when a resin coating is to be formed on the inorganic particles by the method discussed in Japanese Patent Application Laid-Open No. H05-318605, resin particles injected onto the inorganic particles exposed from the surface of the optically shaped object are sputtered, which makes it difficult to allow the resin particles to dig into the inorganic particles, so that the inorganic particles cannot be coated with a resin coating.

### SUMMARY

The present disclosure is directed to improving the external appearance quality of a three-dimensional shaped object formed of a resin containing inorganic particles by effectively removing an uncured photocurable resin composition in the three-dimensional shaped object.

According to an aspect of the present disclosure, a three-dimensional shaped object includes a layered portion obtained by layering a plurality of resin layers, wherein the three-dimensional shaped object contains a number of inorganic particles, wherein a plurality of inorganic particles among the number of inorganic particles is dispersed into the layered portion, and wherein a layered and shaped surface shaped by each of the plurality of resin layers in the layered portion includes a projection formed of a resin film covering some of the number of inorganic particles, the projection corresponding to a shape of the some of the number of inorganic particles.

According to another aspect of the present disclosure, a manufacturing method of a three-dimensional shaped object using stereolithography includes forming a layered portion by repeatedly performing the following a plurality of times, supplying a photocurable resin composition including at least a photopolymerizable compound, a photopolymerization initiator, and a number of inorganic particles in a layered form, and curing the photocurable resin composition in the layered form by irradiating the photocurable resin composition with an activation energy beam; processing the layered portion using a treatment liquid including a polymerizable compound and a polymerization initiator, and performing a curing process on the treatment liquid adhering to the layered portion.

According to yet another aspect of the present disclosure, a treatment liquid for stereolithography includes a polymerizable compound, a polymerization initiator, and an alcohol organic solvent, wherein a content of the polymerizable compound is 5 mass % or more and 50 mass % or less.

Further features of the present disclosure will become apparent from the following description of exemplary embodiments with reference to the attached drawings.

### BRIEF DESCRIPTION OF THE DRAWINGS

FIG. 1 is a schematic cross-sectional view illustrating a layering direction of a three-dimensional shaped object according to the present disclosure.

FIG. 2 is a schematic view illustrating a configuration example of a stereolithography apparatus using a constrained liquid level method.

FIG. 3 is a flowchart illustrating a method for manufacturing the three-dimensional shaped object according to the present disclosure.

FIGS. 4A to 4C are schematic cross-sectional views illustrating manufacturing processes for the three-dimensional shaped object according to the present disclosure.

FIG. 5 is a schematic diagram illustrating a microscopic laser Raman measurement region.

### DESCRIPTION OF THE EMBODIMENTS

A three-dimensional shaped object according to the present disclosure includes a layered portion obtained by layering a plurality of resin layers, and contains a number of inorganic particles. Some of the number of inorganic particles are present on a layered and shaped surface shaped by each of the plurality of resin layers, and the layered and shaped surface includes a projection formed of a resin film covering the organic particles. The projection corresponds to the shape of the inorganic particles.

Exemplary embodiments of the present disclosure will be described in detail below with reference to the drawings.

### <Three-Dimensional Shaped Object>

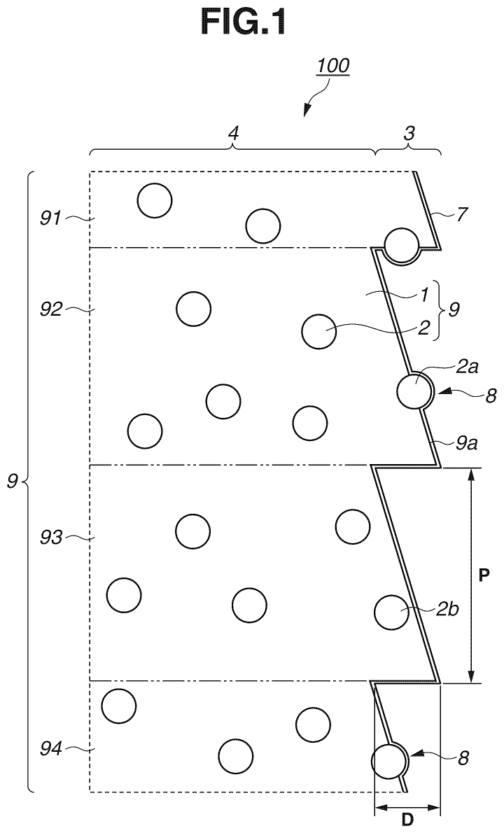

FIG. 1 is a schematic cross-sectional view of a three-dimensional shaped object according to an exemplary embodiment of the present disclosure. FIG. 1 illustrates a schematic cross-sectional view of a layered portion formed by a layering method. FIG. 1 illustrates a three-dimensional shaped object 100 and a layered portion 9 that includes a resin 1 and a large number of inorganic particles 2 dispersed in the resin 1. The term “a number of inorganic particles” and “a large number of inorganic particles” indicate three or more inorganic particles. In practice, 100 or more inorganic particles, or 10,000 or more inorganic particles may be present. The layered portion 9 is obtained by layering a plurality of resin layers (layers 91 to 94 illustrated in FIG. 1) by stereolithography as described below, and a layered and shaped surface 9a has a shape in which concave portions and convex portions are repeated at a predetermined pitch P corresponding to the thickness of the resin layer in a layering direction. FIG. 1 also illustrates concave portions and convex portions 3 of the layered portion 9, and an inside portion 4 that is the inside portion of the layered portion 9 excluding the concave portions and convex portions 3.

FIG. 1 illustrates a configuration example in which the three-dimensional shaped object 100 is exposed to light from the lower side thereof. The upper portion of each of the layers 91 to 94 is underexposed compared to the lower portion thereof, and a side surface of the three-dimensional shaped object 100 has a tapered shape. On the other hand, if the three-dimensional shaped object 100 is exposed to light from the upper side thereof, the lower portion of each of the layers 91 to 94 is underexposed compared to the upper portion thereof, and the side surface of the three-dimensional shaped object 100 has a tapered shape pointing in a direction opposite to the direction of the tapered shape of the three-dimensional shaped object 100 that is exposed to light from the lower side thereof.

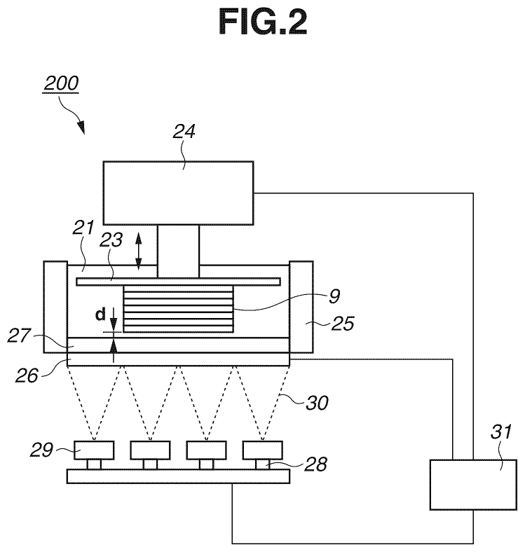

As described below, the pitch P of the concave portions and convex portions 3 corresponds to a thickness d of a photocurable resin composition 21 to be cured by an activation energy beam 30 in a stereolithography apparatus using a constrained liquid level method illustrated in FIG. 2. The thickness d is set based on settings during generation of shaping data for layering of the layered portion 9. The thickness d is obtained such that a control unit 31 controls an ascent-and-descent amount of a shaping stage 23 using a lifting apparatus 24. The thickness d is adjusted within a range of 30 m or more and 150 μm or less, and preferably, 40 μm or more and 100 μm or less, depending on the accuracy of an article to be obtained and a shaping speed. In this case, the adjusted thickness d corresponds to the pitch P of the concave portions and convex portions 3.

Formation of the concave portions and convex portions 3 will now be described. The activation energy beam 30 that has been transmitted through a release transparent film 27 cures the photocurable resin composition 21 with the thickness d. In this case, the activation energy beam 30 attenuates as the activation energy beam 30 is gradually transmitted through the photocurable resin composition 21. Accordingly, the photocurable resin composition 21 in the vicinity of the release transparent film 27 is cured rapidly, while the photocurable resin composition 21 located away from the release transparent film 27 is cured slowly and cannot be sufficiently cured in some cases. In particular, this phenomenon is more likely to occur on the surface of the layered portion 9 that corresponds to a boundary between an irradiated portion that is irradiated with the activation energy beam 30 and a non-irradiated portion that is not irradiated with the activation energy beam 30. Thus, an uncured portion is removed as an uncured photocurable resin composition 21. As a result of removing the uncured photocurable resin composition, the concave portions and convex portions 3 are regularly formed on the layered and shaped surface 9a, and a difference in the height of the concave portions and convex portions 3 corresponds to a difference D in height of concave portions and convex portions of the three-dimensional shaped object 100 finally obtained. Specifically, the difference D is 1 μm or more and 30 μm or less.

The three-dimensional shaped object 100 according to the present exemplary embodiment includes a resin film 7 on the layered and shaped surface 9a. The resin film 7 continuously covers the layered and shaped surface 9a of the layered portion 9 and the surface of inorganic particles 2a exposed from the layered and shaped surface 9a, and forms projections 8 corresponding to the shape of the inorganic particles 2a. While FIG. 1 illustrates an example in which all the inorganic particles 2a located immediately below the resin film 7 forming the projections 8 are buried in the resin 1 of the layered portion 9 and include a portion that is in contact with the resin 1 and a portion that is in contact with the resin film 7, the present exemplary embodiment is not limited to this example. Specifically, the inorganic particles 2 included in the uncured photocurable resin composition remaining on the layered and shaped surface 9a during layering of the layered portion 9 may be left and may be included in the three-dimensional shaped object 100 by the resin film 7 without being in contact with the layered and shaped surface 9a.

The resin film 7 may be the same as or different from the resin 1 constituting the layered portion 9. The resin film 7 may be extremely thin and may preferably have a film thickness of less than 1 m.

The concave portions and convex portions 3 that are formed regularly and linearly can mattify the surface of the three-dimensional shaped object 100. Without the projections 8, color unevenness can occur on the regular structure depending on the angle with which the regular structure is viewed. However, the presence of the concave portions and convex portions 3 and the projections 8 that are randomly arranged can eliminate the color unevenness due to the regular structure, so that the external appearance quality can be improved.

Since the resin film 7 covering the projections 8 is extremely thin, the inorganic particles 2a located immediately below the resin film 7 forming the projections 8 appear to strongly reflect light when the inorganic particles 2a are observed with an epi-illumination light microscope. Therefore, the inorganic particles 2a can be distinguished from inorganic particles 2b that are buried in the vicinity of the surface of the three-dimensional shaped object 100.

### <Photocurable Resin Composition>

The layered portion 9 is formed by light curing a photocurable resin composition containing a photopolymerizable compound, a photopolymerization initiator, and a large number of inorganic particles 2. In addition, a colorant or other additives may be added, as needed, to the photocurable resin composition.

### [Photopolymerizable Compound]

As the photopolymerizable compound for use in the present exemplary embodiment, for example, an acrylate-based, urethane acrylate-based, or vinyl-based radical polymerizable compound and oligomers thereof, or an epoxy-based, oxetane-based, or vinyl ether-based cationic polymerizable compound and oligomers thereof may be used. Among these, an acrylate-based or urethane acrylate-based polymerizable compound may be preferably used because the acrylate-based or urethane acrylate-based polymerizable compound can have high polymerizability and can provide various functions. As such polymerizable compounds, one type of polymerizable compound may be used singly, or two or more types of polymerizable compound may be used in combination.

### [Photopolymerization Initiator]

A photopolymerization initiator can be decomposed by an activation energy beam and can generate radicals or/and cations. The generated radicals or/and cations cause polymerization of the polymerizable compound, thereby curing the photocurable resin composition. The photopolymerization initiator can be appropriately selected depending on curing conditions (irradiation wavelength, irradiation energy) for the photopolymerizable compound to be used.

Examples of the type of the photopolymerization initiator to be used may include an acetophenone-based, acylphosphine oxide-based, titanocene-based, or oxime ester-based photo-radical polymerization initiator, and a triarylsulfonium salt-based, diaryliodonium salt-based, oxime sulfonate-based, imide sulfonate-based, or trichloromethyl triazine-based photo cationic polymerization initiator.

It may be preferable to use a photopolymerization initiator that generates radicals due to irradiation of an activation energy beam with a wavelength of 300 nm or more and 450 nm or less because a versatile mercury lamp or light-emitting diode (LED) can be used.

One type of photopolymerization initiator may be used singly, or two or more types of photopolymerization initiator may be used in combination. The added amount of the photopolymerization initiator may be preferably in a range of 0.01 parts by mass or more and 10.00 parts by mass or less with respect to 100 parts by mass of photopolymerizable compound. A ratio of the photopolymerization initiator to be added may be appropriately selected depending on the irradiation amount of activation energy beam and an additional heating temperature. Further, the ratio of the photopolymerization initiator to be added may be adjusted depending on a target average molecular weight of a polymer to be obtained.

### [Inorganic Particles]

In the present exemplary embodiment, inorganic particles are added to the photocurable resin composition of the material so as to improve characteristics such as mechanical properties, flame retardancy, and electrical conductivity of the three-dimensional shaped object 100.

The particle size of inorganic particles varies depending on the material to be used. The average particle size of inorganic particles may be preferably 3 μm or more and 25 μm or less. When the average particle size is 3 μm or more, an appropriate amount of inorganic particles used to improve the characteristics can be obtained. When the average particle size is 25 μm or less, light scattering during photo-curing is suppressed and shaping can be performed favorably.

In the case of adding flame-retardant inorganic particles, phosphate-based flame retardant particles may be preferably used. Preferable examples of the phosphate-based flame retardant particles include polyphosphate such as ammonium polyphosphate.

The added amount of inorganic particles may be preferably in a range of 10.00 parts by mass or more and 40.00 parts by mass or less with respect to 100 parts by mass of the sum of the photopolymerizable compound and the photopolymerization initiator.

### [Colorant]

A colorant may be added to the photocurable resin composition of the material, for example, to adjust the hardness or tint of the three-dimensional shaped object 100 by adjusting ultraviolet light to be absorbed in the photocurable resin composition. Examples of the colorant for adjusting the absorption of ultraviolet light include a carbon black. As the colorant for adjusting the tint, various organic pigments and inorganic pigments can be used.

The added amount of the colorant may be preferably in a range of 0.001 parts by mass or more and 1.00 parts by mass or less with respect to 100 parts by mass of the sum of the photopolymerizable resin, the photocurable polymerization initiator, and the inorganic particles.

### <Manufacturing Method of Three-Dimensional Shaped Object>

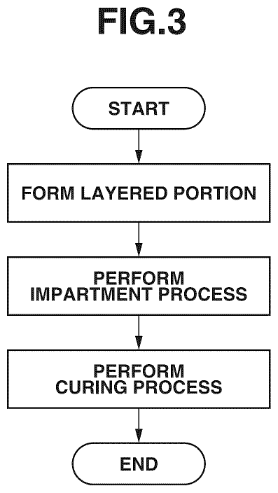

FIG. 3 is a flowchart illustrating manufacturing processes for the three-dimensional shaped object 100 according to the present exemplary embodiment. As illustrated in FIG. 3, as the manufacturing processes, first, a layered portion is formed using a photocurable resin composition by stereolithography, and then an impartment process is performed. An example of the impartment process may be a cleaning process of cleaning the layered portion with a treatment liquid to remove an uncured photocurable resin composition. After the cleaning process, another process may be performed. Finally, the polymerizable compound in the cleaning fluid adhering to the surface of the layered portion is cured to form a resin film on the surface.

### [Formation of Layered Portion]

Examples of a method for forming the layered portion include a method of repeatedly performing the following processes a plurality of times, that is, the process of supplying a photocurable resin composition with a predetermined thickness based on shaping data generated based on three-dimensional shape data on an object to be manufactured (three-dimensional model), and the process of curing the supplied photocurable resin composition.

The stereolithography method can be roughly divided into two types of methods, i.e., a free liquid level method and a constrained liquid level method.

FIG. 2 illustrates a configuration example of a shaping apparatus 200 using the constrained liquid level method. The shaping apparatus 200 includes a container 25 that contains the liquid photocurable resin composition 21. On the inside of the container 25, the shaping stage 23 that is configured to ascend or descend in the vertical direction by the lifting apparatus 24 and the control unit 31 is provided. The activation energy beam 30 for curing the photocurable resin composition 21 is injected from a light source 28 by the control unit 31 and is magnified by the lens unit 29. After that, an irradiation region is controlled by the control unit 31 and a liquid crystal shutter 26 to be controlled based on shaping data. The activation energy beam 30 that has been transmitted through the liquid crystal shutter 26 passes through the release transparent film 27 and cures the photocurable resin composition 21.

The thickness d of the photocurable resin composition 21 to be cured by the activation energy beam 30 is a value set based on settings during generation of shaping data and affects the accuracy of an article to be obtained (reproducibility of three-dimensional shape data on an article to be shaped). The thickness d is obtained such that the control unit 31 controls the ascent-and-descent amount of the shaping stage 23 by the lifting apparatus 24. In this case, concave portions and convex portions that are repeated at the predetermined pitch corresponding to the thickness d are formed on the surface of the layered portion 9 in the direction vertical to an ascending-and-descending direction of the shaping stage 23.

First, the control unit 31 controls the lifting apparatus 24 based on settings and the shaping surface of the shaping stage 23 and the release transparent film 27 are placed at a predetermined distance. The photocurable resin composition is supplied to a space between the shaping surface of the shaping stage 23 and the release transparent film 27. Next, the container 25 containing the photocurable resin composition is irradiated with the activation energy beam 30 from the lower side of the container 25. The irradiation of the activation energy beam 30 enables the photocurable resin composition in the space between the shaping surface of the shaping stage 23 and the release transparent film 27 to be cured, thereby forming a cured layer in a solid state.

A predetermined amount of the activation energy beam 30 is irradiated to cure the photocurable resin composition, and then the shaping stage 23 is caused to ascend, thereby allowing the cured layer to be peeled off from the release transparent film 27.

Next, the height of the shaping stage 23 is adjusted so as to set the predetermined distance between the cured layer formed below the shaping stage 23 and the release transparent film 27. Then, in the same manner as described above, the photocurable resin composition is supplied to the space between the cured layer and the release transparent film 27 and is irradiated with the activation energy beam 30 based on shaping data to thereby form a new cured layer between the previous cured layer and the release transparent film 27. This process is repeatedly performed a plurality of times to thereby obtain the layered portion 9 formed by layering a plurality of cured layers in an integrated manner.

The light source 28 is not limited to an LED light, but instead may be a laser light source or a projector. In the case of using a laser light source, the irradiation amount per unit area is controlled based on the illuminance and scanning speed, and there is no need to provide the liquid crystal shutter 26. In addition to the liquid crystal shutter 26, a digital micromirror shutter may also be used.

The shaping apparatus using the free liquid level method has a configuration in which the shaping stage 23 of the shaping apparatus 200 illustrated in FIG. 2 is provided to cause the layered portion 9 to descend to the lower side of the liquid level, the light source 28 is provided above the container 25, and the cured layer is formed on the shaping stage 23.

A representative example of the free liquid level method is as follows. First, the shaping surface of the shaping stage 23 provided to freely ascend or descend is caused to descend so as to set the predetermined distance d from the liquid level of the photocurable resin composition contained in the container 25.

After that, the shaping stage 23 is caused to descend to supply the uncured photocurable resin composition with the thickness d to the surface of the cured layer. Then, the activation energy beam is irradiated based on shaping data, thereby forming a cured object integrated with the cured layer previously formed. The process of curing the photocurable resin composition in a layered form is repeatedly performed to thereby obtain a target three-dimensional optically shaped object. The subsequent process is similar to that in the constrained liquid level method.

Both the constrained liquid level method and the free liquid level method can use ultraviolet light, electron beam, X-ray, radiation, high-frequency wave, and the like as the activation energy beam 30. Among these, ultraviolet light having a wavelength of 300 nm or more and 450 nm or less may be preferably used from an economic perspective. Examples of the light source that can be used in this case include an ultraviolet LED, ultraviolet light laser (e.g., semiconductor-pumped solid-state laser, an argon (Ar) laser, or a helium (He)-cadmium (Cd) laser), a high-pressure mercury lamp, a super high-pressure mercury lamp, a mercury lamp, a xenon lamp, a halogen lamp, a metal halide lamp, and a fluorescent light.

### [Surface Treatment for Layered Portion]

The layered portion 9 obtained as described above is taken out of the container 25. Then, a surface treatment (cleaning) is performed using a treatment liquid for stereolithography and a curing process (post-curing) using one or both of light irradiation and heat radiation are performed to thereby obtain the three-dimensional shaped object 100 according to the present exemplary embodiment.

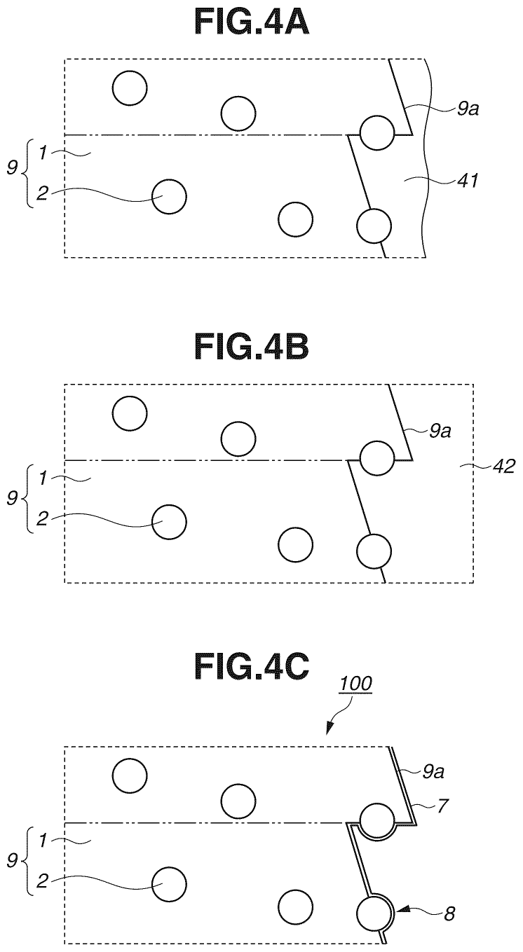

FIGS. 4A to 4C are schematic cross-sectional views each illustrating a layering method for the layered portion 9, including the processes from the surface treatment to the curing process for the layered portion 9. FIG. 4A illustrates a state where the layered portion 9 is taken out of the container 25 immediately after the formation of the layered portion 9, and an uncured photocurable resin composition 41 is adhering to the surface of the layered portion 9. A treatment liquid 42 is brought into contact with the surface of the layered portion 9 in this state to remove the uncured photocurable resin composition 41 (FIG. 4B). Next, the curing process is performed in a state where the treatment liquid 42 is adhering to the surface of the layered portion 9, so that the resin film 7 is formed on the layered and shaped surface 9a of the layered portion 9 and the surface of the inorganic particles 2 exposed from the layered and shaped surface 9a (FIG. 4C).

As the treatment liquid 42 to be used for the surface treatment may include at least a polymerizable compound and a polymerization initiator. A photopolymerizable compound may be preferably used as the polymerizable compound. Further, an alcohol-based organic solvent, preferably, a primary alcohol may be used. Specifically, it may be preferable to use an ethyl alcohol or an isopropyl alcohol. A photopolymerizable compound and a photopolymerization initiator are added to such alcohol-based organic solvents to be used. The photopolymerizable compound and the photopolymerization initiator may be preferably the same type as that used to form the layered portion 9. The content of the photopolymerizable compound in the treatment liquid 42 is 5 mass % or more and 50 mass % or less, preferably, 7 mass % or more and 40 mass % or less, and more preferably, 10 mass % or more and 30 mass % or less.

When the layered portion 9 is immersed in the treatment liquid 42, the layered portion 9 may be taken out of the container 25 after the layered portion 9 is immersed in the treatment liquid 42 depending on the shape of the layered portion 9, or the layered portion 9 may be taken out of the container 25 after the layered portion 9 is immersed in the treatment liquid 42 while the treatment liquid 42 is stirred or is subjected to ultrasonic vibrations. The immersion time is adjusted depending on the shape of the layered portion 9.

The curing process allows the polymerizable compound in the treatment liquid 42 adhering to the surface of the layered portion 9 to be cured and allows the unreacted photopolymerizable compound remaining within the layered portion 9 to be cured, thereby improving the early age strength of the layered portion 9.

As the wavelength for light irradiation in the curing process, wavelengths for promoting curing of the polymerizable compound in the treatment liquid 42 may be suitably used. Among these wavelengths, ultraviolet light having a wavelength of 300 nm or more and 450 nm or less may be preferably used from an economic perspective. The irradiation time is adjusted within a range of one hour to two hours depending on the shape of the shaped object and the mechanical strength of a target shaped object. In the heat radiation process, the temperature and irradiation time are adjusted depending on the shape of the layered object and the mechanical strength of the target three-dimensional shaped object 100 within a range in which the shape of the layered object is not drastically changed.

As described above, the three-dimensional shaped object 100 according to the present exemplary embodiment includes concave portions and convex portions that are repeated at the predetermined pitch on the layered and shaped surface 9a of the layered portion 9, and also includes projections each formed of a resin film covering inorganic particles depending on the shape of the inorganic particles on the surface of the concave portions and convex portions 3. Thus, the concave portions and convex portions 3 that are repeated at the predetermined pitch are formed on the surface and the projections 8 are formed on the surface of the concave portions and convex portions 3, which allows light incident on the surface of the three-dimensional shaped object 100 to be scattered and suppresses unevenness of reflection of light to be strongly reflected in a specific direction.

If the layered and shaped surface 9a of the layered portion 9 is not provided with any resin film and includes only the concave portions and convex portions 3, regular streaks due to the concave portions and convex portions 3 can be visually recognized in some cases. However, the projections 8 provided on the surface of the concave portions and convex portions 3 make it difficult to visually recognize the regular streaks. The surface of the inorganic particles located immediately below the resin film 7 forming the projections 8 is covered with the resin film 7, thereby suppressing color unevenness. With the configurations described above, the three-dimensional shaped object 100 with an excellent external appearance quality can be provided.

When the inorganic particles are covered with the resin film 7, falling-off of the inorganic particles is suppressed, and when the inorganic particles are used as a flame retardant, deterioration in the frame retardancy of the three-dimensional shaped object 100 due to falling-off of the flame retardant can be suppressed.

### <Measurement of Pitch and Difference in Height of Concaves and Convex Portions>

In the present exemplary embodiment, the shape of the concave portions and convex portions 3 on the layered and shaped surface 9a of the layered portion 9 is measured by a laser microscope for the three-dimensional shaped object 100, but instead may be measured by any other method with which the surface shape can be evaluated, such as a light microscope, scanning electron microscopy (SEM), scanning probe microscopy (SPM), atomic force microscopy (AFM), or a surfcorder.

### <Observation of Projections>

In the present exemplary embodiment, the projections 8 on the surface of the three-dimensional shaped object 100 are observed with an epi-illumination light microscope. Specifically, a region including the concave portions and convex portions 3 that are repeated at the predetermined pitch is defined by laser microscopic observation, SEM observation, or the like. This region is observed with a light microscope to observe the projections 8 on the surface of the concave portions and convex portions 3. Assume herein that the “inorganic particles” covered with the resin film 7 on the surface of the concave portions and convex portions 3 are inorganic particles on which light is reflected in the same manner as light reflected on the cross-section of each inorganic particle located in the inside portion 4 illustrated in FIG. 1 relative to the concave portions and convex portions 3 in FIG. 1 on the layered and shaped surface 9a of the three-dimensional shaped object 100 under the light microscope observation.

As illustrated in FIG. 1, the inorganic particles 2 located in the inside portion 4 relative to the concave portions and convex portions 3 on the layered and shaped surface 9a of the three-dimensional shaped object 100 are exposed by the following method. That is, the three-dimensional shaped object 100 is cut and a cut area in the inside portion 4 relative to the concave portions and convex portions 3 is subjected to cross-sectioning by ion milling, a microtome, Focused Ion Beam (FIB), or the like, thereby exposing the inorganic particles 2. The inorganic particles exposed using a probe of a micromanipulator, a hand-held needle, or the like may be obtained from the cut area or the cross-section obtained by cross-sectioning.

In addition, inorganic particles may be obtained by digging the three-dimensional shaped object 100 with a micromanipulator. For example, the surface of the three-dimensional shaped object 100 may be dug with a micromanipulator, and when the surface is dug to a depth that reaches an area more inward than the concave portions and convex portions 3, inorganic particles may be obtained using the probe of the micromanipulator. Alternatively, inorganic particles may be dug out with a micromanipulator from the cut area or the cross-section obtained by cross-sectioning, of the three-dimensional shaped object 100, and then the inorganic particles may be obtained using the probe of the micromanipulator.

Contamination adhering to the surface is removed with an organic solvent such as an ethyl alcohol, and then the inorganic particles with an exposed cross-section and the obtained inorganic particles are observed with a light microscope.

The projections 8 on the concave portions and convex portions 3 on the surface of the three-dimensional shaped object 100 may be observed by any other method with which the surface shape and exposed state can be evaluated, such as a laser microscope or SEM.

### <Observation of Cross-Section of Projections>

In the present exemplary embodiment, the above-described observation of the cross-section of each projection 8 on the surface of the concave portions and convex portions 3 is performed by SEM. Specifically, the three-dimensional shaped object 100 including concave portions and convex portions 3 is cut to be subjected to cross-sectioning by ion milling, a microtome, FIB, or the like, thereby exposing the cross-section of each projection 8 on the surface of the concave portions and convex portions 3. This cross-section is observed by SEM.

### <Measurement of Degree of Coverage of Resin Film on Projections>

In the present exemplary embodiment, the degree of coverage of the resin film 7 on each projection 8 on the surface of the concave portions and convex portions 3 is measured by microscopic laser Raman spectroscopy. This measurement method will be described below.

On the surface of the three-dimensional shaped object 100, a region including the concave portions and convex portions 3 that are repeated at the predetermined pitch is defined by laser microscopic observation, SEM observation, or the like. In this region, five locations with relatively high lightness are measured by a spectrophotometric colorimeter, and a region of 300 μm×300 μm at the center of the measurement location with maximum L* is defined as a microscopic laser Raman measurement region. Assume that the measurement locations to be measured by the spectrophotometric colorimeter are apart from each other by 10 mm or more. If the three-dimensional shaped object 100 is small and the number of regions that can be measured by the spectrophotometric colorimeter is less than five, a region of 300 μm×300 μm at the center of the measurement location with maximum L* within a maximum number of locations that can be measured is defined as the microscopic laser Raman measurement region. In the region including concave portions and convex portions 3 that are repeated at the predetermined pitch, if the lightness on the entire region is uniform and it is difficult to distinguish a portion with relatively high lightness from a portion with relatively low lightness, five arbitrary locations are measured and a region of 300 μm×300 μm at the center of the measurement location with maximum L* is defined as the microscopic laser Raman measurement region.

In the microscopic laser Raman measurement region, inorganic particles which are located at vertices of the projections 8, respectively, and on which light is reflected in the same manner as light reflected on the cross-section of each inorganic particle located in an area more inward than the concave portions and convex portions 3 on the layered and shaped surface 9a of the three-dimensional shaped object 100 under the epi-illumination light microscope observation are measured by microscopic laser Raman spectroscopy. A laser spot diameter corresponds to the area of one inorganic particle, and the irradiation time and the number of integrated times for measurement are adjusted so as to obtain a sufficiently high Raman intensity.

If a cosmic ray is detected in a Raman spectrum of the measured inorganic particles, the cosmic ray is removed and data obtained after a baseline correction process is performed is set as Raman spectrum measurement data.

In the Raman spectrum measurement data, five highest Raman intensities derived from the inorganic particles are obtained and an average value of the five highest Raman intensities is calculated.

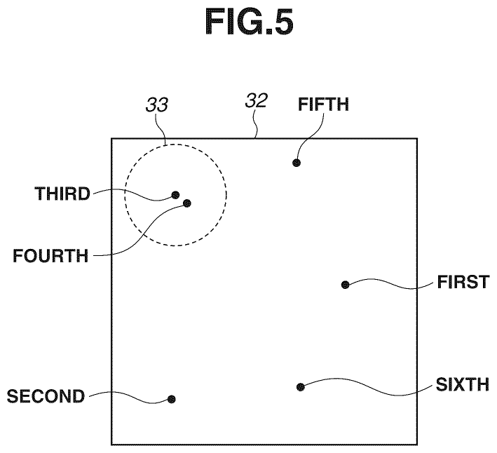

However, if there is a measurement location where the intensity based on which the average value is calculated is measured, within a distance of 50 μm from the Raman measurement locations that are already used for calculation of the average value, this measurement location is excluded and the next intensity is to be obtained. This method will be described with reference to FIG. 5. In a microscopic laser Raman measurement region 32, a first measurement location, a second measurement location, a third measurement location, a fourth measurement location, and a fifth measurement location are set in descending order of the measured intensities derived from the inorganic particles. Among these measurement locations, the fourth measurement location is located within a range 33 that is at a distance of 50 μm or less from the third measurement location. However, since the third measurement location is already used for calculation of the average value, the fourth measurement location is excluded. The fifth and sixth measurement locations are not within the range of 50 μm from the Raman measurement locations already used for calculation of the average value. Accordingly, the fifth and sixth measurement locations are used to calculate the average value. Thus, the first, second, third, fifth, and sixth measurement locations are used to calculate the average value. The above-described process is repeated until five intensities based on which the average value is calculated can be obtained.

If the number of microscopic laser Raman measurement locations where the intensities are obtained within the range of 300 μm×300 μm in the microscopic laser Raman measurement region is less than five, a region of 300 μm×300 μm that is adjacent to the microscopic Raman measurement region located at the center thereof is obtained and this process is repeated until five intensities based on which the average value is calculated can be obtained. If the number of microscopic laser Raman measurement locations in the measurement location with maximum L* is less than five, the measurement location with the second highest L* is set as the microscopic laser Raman measurement region and this process is repeated until five intensities based on which the average value is calculated can be obtained.

### <Measurement of Average Particle Size of Inorganic Particles>

In the present exemplary embodiment, the particle size of the inorganic particles is measured by image processing on a cross-sectional image of the three-dimensional shaped object 100. This measurement method will be described below.

The three-dimensional shaped object 100 is cut with a cutter and the cross-section of the three-dimensional shaped object 100 is subjected to polishing. This polished surface is processed by ion milling. The polished surface may be processed not only by ion milling, but also by a microtome or FIB. Further, the processed surface is coated with osmium with an osmium coater. The processed surface may be coated with carbon using a carbon coater.

The processed surface is observed by SEM. It may be preferable to use reflected electrons for observation because the difference in contrast between the inorganic particles and the resin composition is large and thus clear inorganic particle images can be obtained. The process of cross-sectioning and the process of observation by SEM may be continuously performed using a Focused Ion Beam Scanning Electron Microscope (FIB-SEM).

Image processing is performed on the obtained observed image using image processing software such as ImagePro, thereby measuring the equivalent circle diameter of each inorganic particle and obtaining the average particle size.

### <Measurement of Average Particle Size of Colorant>

In the present exemplary embodiment, the particle size of the colorant is measured by image processing on a cross-sectional image of the three-dimensional shaped object 100. This measurement method is identical to the method of measuring the average particle size of the inorganic particles described above.

### <Measurement by Spectrophotometric Colorimeter>

On the surface including the concave portions and convex portions 3 on the layered and shaped surface 9a of the layered portion 9, three points with relatively high lightness and three points with relatively low lightness are measured by the spectrophotometric colorimeter. If the lightness on the entire region is uniform and it is difficult to distinguish a portion with relatively high lightness from a portion with relatively low lightness, six arbitrary points are measured. Assume that the spectrophotometric colorimeter measurement locations are apart from each other by 10 mm or more.

### Use Application

The three-dimensional shaped object 100 according to the present exemplary embodiment can be suitably used for three-dimensional layering shaping, in particular, stereolithography. The three-dimensional shaped object 100 according to the present exemplary embodiment, which can be obtained by a three-dimensional (3D) printer, can be widely used in the field of stereolithography. Typical application fields include, but are not limited to, prototype models of industrial products, including electric and electronic appliances, OA equipment, camera, computer, medical equipment, and industrial equipment, design models, working models, base models for producing molds, direct molds for prototype molds, service parts, housings, and parts of industrial products. In particular, the three-dimensional shaped object 100 according to the present exemplary embodiment can be used in the manufacture of housings and parts of industrial products because the three-dimensional shaped object 100 has excellent external appearance quality.

### <Manufacturing of Three-Dimensional Shaped Object>

A photocurable resin composition was prepared by mixing the following materials with the following compositions.

### Materials

Polymerizable compound (A): 2-(Allyloxymethyl) acrylic acid methyl ester (trade name “FX-AO-MA” manufactured by Nippon Shokubai Co., Ltd.)
Polymerizable compound (B): urethane acrylate (trade name “KAYARAD UC-6101” manufactured by Nippon Kayaku Co., Ltd.)
Polymerizable compound (C): tris-(2-(acryloxy) ethyl) isocyanurate (trade name “A-9300” manufactured by SHIN-NAKAMURA CHEMICAL CO, LTD.)
Photopolymerization initiator (D): bis(2,4,6-trimethylbenzoyl) phenylphosphine oxide (trade name “Omnirad819” manufactured by I.G.M Resins B.V.)
Inorganic particles (E): ammonium polyphosphate (trade name “Exolit AP423” manufactured by Clariant AG)
Colorant (F): carbon black (trade name “Mitsubishi Chemical MA-100” manufactured by Mitsubishi Chemical Group Corporation) [Composition]
Polymerizable compound (A): 25 parts by mass
Polymerizable compound (B): 35 parts by mass
Polymerizable compound (C): 40 parts by mass
Photopolymerization initiator (D): 3 parts by mass
Inorganic particles (E): 30 parts by mass with respect to the sum of (A)+(B)+(C)+(D)
Colorant (F): 0.02 parts by mass with respect to the sum of (A)+(B)+(C)+(D)+(E)

The above-described photocurable resin composition was used to form the layered portion by a 3D printer (trade name “M1370” manufactured by SUMAOPAI). The thickness of one layer to be layered was 50 μm and the irradiation time per layer was four seconds.

The obtained layered portion was taken out of the shaping stage and was immersed in an ultrasonic cleaning device (trade name “ASU-20D” manufactured by AS ONE Corporation) filled with a treatment liquid. The treatment liquid obtained by mixing 25 parts by mass of polymerizable compound (A), 35 parts by mass of polymerizable compound (B), 40 parts by mass of polymerizable compound (C), and 3 parts by mass of photopolymerization initiator (D) and diluting this mixture in an ethyl alcohol at a density of 15 mass % was used. Then, ultrasonic waves of 43 kHz were applied to the layered portion for one minute and the layered portion was processed within a temperature range of 20° C. to 30° C.

As the curing process, a secondary curing process was performed for one hour by a secondary curing device (trade name “LC-3D Print Box” manufactured by 3D Systems Corporation) Then, the layered portion was put into a heating oven at 100° C. and was heated for two hours, so that the three-dimensional shaped object was obtained.

### <Measurement of Concaves and Convex Portions>

The surface of the three-dimensional shaped object was measured by a laser microscope (trade name “OPTELICS HYBRID+” manufactured by Lasertec Corporation). Concaves and convex portions repeated at a predetermined pitch corresponding to the thickness of one layered layer were observed on the surface vertical to the ascending-and-descending direction of the shaping stage, and this shape was measured. In this shape, the pitch P of the concave portions and convex portions was 45 μm to 55 μm and the difference D in height of the concave portions and convex portions was 5 μm to 25 μm.

### <Observation of Projections>

The projections on the surface of concave portions and convex portions on the surface of the three-dimensional shaped object observed with the laser microscope were observed. This observation was performed using an epi-illumination light microscope included in a Raman laser microscope (trade name “inVia Qontor” manufactured by RENISHAW). It was confirmed that there were inorganic particles on which light was reflected in the same manner as light reflected on the cross-section of each inorganic particle located in an area more inward than the concave portions and convex portions on the layered and shaped surface of the three-dimensional shaped object under the light microscope observation.

The inorganic particles located in an area more inward than the concave portions and convex portions on the layered and shaped surface of the three-dimensional shaped object were exposed by the following method. That is, the three-dimensional shaped object was cut with a cutter (trade name “IsoMet” manufactured by BUEHLER) and the cut area was subjected to final polishing by a polishing machine (trade name “ISSP-1000” manufactured by Ikegami Seiki Co., Ltd.) using a colloidal silica slurry (trade name “MasterMet” manufactured by BUEHLER).

This polished surface was processed by ion milling (trade name “IM4000 PLUS” manufactured by Hitachi High-Tech Corporation). After contamination adhering to the processed surface was removed with ethyl alcohol, the inorganic particles were observed with a light microscope.

### <Observation of Cross-Section of Projections>

After the portion including concave portions and convex portions on the surface of the three-dimensional shaped object was cut with a cutter (trade name “IsoMet” manufactured by BUEHLER), the cut area was subjected to final polishing by a polishing machine (trade name “ISSP-1000” manufactured by Ikegami Seiki Co., Ltd.) using a colloidal silica slurry (trade name “MasterMet” manufactured by BUEHLER). This polished surface was processed by ion milling (trade name “IM4000 PLUS” manufactured by Hitachi High-Tech Corporation). The processed surface was coated with osmium with a thickness of 5 nm by an osmium coater (trade name “Tennant20” manufactured by MEIWAFOSIS CO., LTD.).

The processed surface was observed by SEM (trade name “Teneo” manufactured by FEI). As a result, the thickness of the resin film on each projection was less than 1 km.

### <Measurement of Degree of Coverage of Resin Film on Projections>

In the measurement of the degree of coverage of the resin film on the projections, first, the cross-section of each inorganic particle located in an area more inward than the concave portions and convex portions on the layered and shaped surface of the three-dimensional shaped object was measured by a Raman laser microscope (trade name “inVia Qontor” manufactured by RENISHAW). As Raman measurement conditions, the measurement was performed at a 100-fold magnification of an objective lens, with a laser wavelength of 532 nm, and with a grading of 1800 l/mm, 1000 cm⁻¹ was set as the center of the measurement spectrum range by setting the grading at a fixed position, the irradiation time was 10 seconds, laser power was 0.009375%, and the number of integrated times for measurement was 50.

Upon detection of a cosmic ray in the Raman spectrum of the measured inorganic particles, the cosmic ray was removed and the baseline correction process was performed. In the Raman spectrum measurement data, it was confirmed that a peak derived from inorganic particles was at 1139 cm⁻¹. A microscopic laser Raman measurement for five locations was performed on the cross-section of this inorganic particle, intensities at 1139 cm⁻¹ were obtained, and the average value (AVEᵢₙₜₑᵣₙₐₗ) of the intensities was calculated. In this case, the measured cross-sections of the inorganic particles were apart from each other by 50 μm or more.

Next, the microscopic laser Raman measurement on the surface of the three-dimensional shaped object was performed as described below. On the surface including the concave portions and convex portions observed with the laser microscope, five locations of with relatively high lightness were measured by a spectrophotometric colorimeter (trade name “CM-2600d” manufactured by KONICA MINOLTA, INC.). The three-dimensional shaped object was evaluated based on L* in a Specular Component Excluded (SCE) method under measurement conditions of φ3 mm, L*a*b*, D50, and 10°. In this case, the spectrophotometric colorimeter measurement locations were apart from each other by 10 mm or more. A region of 300 μm×300 μm at the center of the measurement location with maximum L* among the five measurement locations was defined as the microscopic laser Raman measurement region. When the three-dimensional shaped object was small and the number of regions that can be measured by the spectrophotometric colorimeter was less than five, a region of 300 μm×300 μm at the center of the measurement location with maximum L* within a maximum number of locations that can be measured was defined as the microscopic laser Raman measurement region.

In the microscopic laser Raman measurement region, the microscopic laser Raman measurement was performed on the inorganic particles which were located at vertices of the projections, respectively, and on which light was reflected in the same manner as light reflected on the cross-section of each inorganic particle located in an area more inward than the concave portions and convex portions on the layered and shaped surface of the three-dimensional shaped object under the epi-illumination light microscope observation. The Raman measurement conditions were same as those for the measurement on the cross-section of each inorganic particle described above.

Upon detection of a cosmic ray in the Raman spectrum of the measured inorganic particles, the cosmic ray was removed and data obtained after the baseline correction process was performed was set as Raman spectrum measurement data.

In the Raman spectrum measurement data, at 1139 cm¹ of a peak of Raman intensities derived from the inorganic particles, five intensities in descending order of intensities were obtained and the average value (AVEₛₜₑₚ) of the five intensities was calculated.

Further, a ratio (AVEₛₜₑₚ/AVEᵢₙₜₑᵣₙₐₗ) between the average value of the intensities at the five locations on the cross-section of each inorganic particle and the average value of the intensities at the five locations of inorganic particles which were located at vertices of the projections, respectively, and on which light was reflected in the same manner as light reflected on the cross-section of each inorganic particle located in an area more inward than the concave portions and convex portions on the layered and shaped surface of the three-dimensional shaped object under the light microscope observation in the microscopic laser Raman measurement region was calculated. Table 1 shows the calculation results.

### <Measurement of Average Particle Size of Inorganic Particles>

The three-dimensional shaped object was cut by a cutter (trade name “IsoMet” manufactured by BUEHLER), and then the cut area was subjected to final polishing by a polishing machine (trade name “ISSP-1000” manufactured by Ikegami Seiki Co., Ltd.) using a colloidal silica slurry (trade name “MasterMet” manufactured by BUEHLER).

This polished surface was processed by ion milling (trade name “IM4000 PLUS” manufactured by Hitachi High-Tech Corporation). The processed surface was coated with osmium with a thickness of 5 nm by an osmium coater (trade name “Tennant20” manufactured by MEIWAFOSIS CO., LTD.).

The coated processed surface was observed by SEM (trade name “Teneo” manufactured by FEI). The observation was performed using reflected electrons, so that the difference in contrast between the inorganic particles and the resin was large and thus a clear inorganic particle image was obtained. The observation was performed at a 1000-fold magnification. The obtained image was processed by image processing software (trade name “Image-Pro 10” manufactured by MEDIA CYBERNETICS), thereby measuring the equivalent circle diameter of the inorganic particles and obtaining the average particle size of the inorganic particles. The result was 6.2 m.

### <Measurement of Average Particle Size of Colorant>

Like in the measurement of the average particle size of the inorganic particles, the coated processed surface was obtained. The coated processed surface was observed at a 25000-fold magnification of SEM. The obtained image was processed by the image processing software described above, thereby measuring the equivalent circle diameter of the colorant and obtaining the average particle size of the colorant. The result was 50 nm.

### <Measurement of Spectrophotometric Colorimeter>

On the surface including the concave portions and convex portions of the three-dimensional shaped object, three points with relatively high lightness and three points with relatively low lightness were to be measured by the spectrophotometric colorimeter described above. However, since the lightness on the entire region was uniform, the measurement was performed on six measurement locations such that the measurement locations were apart from each other by 10 mm or more. The three-dimensional shaped object was evaluated based on L* in the SCE method under measurement conditions of (φ3 mm, L*a*b*, D50, and 10°. As a result, the difference between maximum L* and minimum L* was 0.2.

In Example 2, a three-dimensional shaped object was prepared in the same manner as in Example 1, except that the density at which the mixture of polymerizable compounds (A), (B), and (C), and photopolymerization initiator (D) was diluted in an ethyl alcohol was changed to 5 mass %. Further, a sample for evaluation was prepared in the same manner as in Example 1, and the sample was evaluated by the method described in Example 1. Table 1 shows the results.

In Example 3, a three-dimensional shaped object was prepared in the same manner as in Example 1, except that the thickness d of one resin layer to be layered in the layered portion was set to 100 μm and the density at which the mixture of polymerizable compounds (A), (B), and (C), and photopolymerization initiator (D) was diluted in an ethyl alcohol was changed to 50 mass %. Further, a sample for evaluation was prepared in the same manner as in Example 1, and the sample was evaluated by the method described above in Example 1. Table 1 shows the results. When the surface of the obtained three-dimensional shaped object was measured by a laser microscope, concave portions and convex portions repeated at the predetermined pitch were observed and this shape was measured. The pitch of the concave portions and convex portions was 100 m to 105 m and the difference in height of the concave portions and convex portions was 3 μm to 15 m.

In the microscopic Raman laser measurement on the sample for evaluation, there were only a small number of inorganic particles which were located at vertices of the projections, respectively, and on which light was reflected in the same manner as light reflected on the cross-section of each inorganic particle located in an area more inward than the concave portions and convex portions on the layered and shaped surface of the three-dimensional shaped object under the light microscope observation. Accordingly, the microscopic laser Raman measurement was performed on three Raman measurement locations where the intensities were obtained within the range of 300 μm×300 μm of the microscopic laser Raman measurement region. Therefore, a measurement region of 300 m×300 μm adjacent to the measurement region of 300 μm×300 m, which was defined first, was defined. The measurement was also performed on this new measurement region, so that five intensities based on which the average value was to be calculated were obtained.

### Comparative Example 1

In Comparative Example 1, a three-dimensional shaped object was prepared in the same manner as in Example 1, except that the treatment liquid was replaced with an ethyl alcohol. Further, a sample for evaluation was prepared in the same manner as in Example 1, and the sample was evaluated by the method described in Example 1. Table 1 shows the results. In the measurement by the spectrophotometric colorimeter, the difference between maximum L* and minimum L* was 4.7.

### Comparative Example 2

In Comparative Example 2, a three-dimensional shaped object was prepared in the same manner as in Example 1, except that the curing process was performed on the obtained layered portion without performing any surface treatment using the treatment liquid after removing a shaping support portion, and the three-dimensional shaped object was evaluated by the method described in Example 1. Table 1 shows the results.

### Comparative Example 3

In Comparative Example 3, a three-dimensional shaped object was prepared in the same manner as in Example 1, except that the density at which the mixture of polymerizable compounds (A), (B), and (C), and photopolymerization initiator (D) was diluted in an ethyl alcohol was changed to 3 mass %. Further, a sample for evaluation was prepared in the same manner as in Example 1, and the sample was evaluated by the method described in Example 1. Table 1 shows the results. In the measurement by the spectrophotometric colorimeter, the difference between maximum L* and minimum L* was 3.1.

### Comparative Example 4

In Comparative Example 4, a three-dimensional shaped object was prepared in the same manner as in Example 1, except that the density at which the mixture of polymerizable compounds (A), (B), and (C), and photopolymerization initiator (D) was diluted in an ethyl alcohol was changed to 60 mass %. Further, a sample for evaluation was prepared in the same manner as in Example 1, and the sample was evaluated by the method described in Example 1. Table 1 shows the results.

### <Evaluation of Concave Portions and Convex Portions>

The surface of the three-dimensional shaped object was measured by a laser microscope, thereby confirming the presence of concave portions and convex portions repeated at the predetermined pitch. Evaluation criteria are defined as follows.

A (good): Concave portions and convex portions that are repeated at the predetermined pitch are present.

B (defective): Concave portions and convex portions that are repeated at the predetermined pitch are not present.

### <Evaluation of Microscopic Laser Raman Measurement>

The ratio of the average value (AVEᵢₙₜₑᵣₙₐₗ) of maximum intensities in the microscopic laser Raman measurement on five measurement locations of each inorganic particle located in an area more inward than the concave portions and convex portions on the layered and shaped surface to the average value (AVEₛₜₑₚ) of maximum intensities in the microscopic laser Raman measurement on five locations of projections on the surface of concave portions and convex portions was calculated and the calculation result was evaluated based on the following criteria.
A (good): AVEₛₜₑₚ/AVEᵢₙₜₑᵣₙₐₗ is ½ or less.
B (defective): AVEₛₜₑₚ/AVEᵢₙₜₑᵣₙₐₗ is more than ½.
- (unmeasurable): No concave portions and convex portions are present and the microscopic laser Raman measurement region cannot be defined.

TABLE 1

| | | | | Com- | Com- | Com- | Com- |
|---|---|---|---|---|---|---|---|
| | | | | par- | par- | par- | par- |
| | Ex- | Ex- | Ex- | tive | tive | tive | tive |
| | am- | am- | am- | Exam- | Exam- | Exam- | Exam- |
| | ple | ple | ple | ple | ple | ple | ple |
| | 1 | 2 | 3 | 1 | 2 | 3 | 4 |
| Evaluation of | A | A | A | A | B | A | B |
| Concave | | | | | | | |
| portions and | | | | | | | |
| Convex | | | | | | | |
| portions | | | | | | | |
| AVEₛₜₑₚ/ | A | A | A | B | — | B | — |
| AVEᵢₙₜₑᵣₙₐₗ | | | | | | | |

Comparing Examples 1 to 3 with Comparative Examples 1 to 4, Table 1 shows that concave portions and convex portions repeated at the predetermined pitch were present on the surface of the three-dimensional shaped objects according to Examples 1 to 3 and the ratio AVEₛₜₑₚ/AVEᵢₙₜₑᵣₙₐₗ was ½ or less in the three-dimensional shaped objects according to Examples 1 to 3. Accordingly, color unevenness did not occur on the surface and the three-dimensional shaped object with an excellent external appearance quality was obtained. On the projections on the surface of the concave portions and convex portions on which the microscopic laser Raman measurement was performed in the three-dimensional shaped objects according to Examples 1 to 3, light was reflected in the same manner as light reflected on the cross-section of each inorganic particle under the epi-illumination light microscope observation. However, since the surface of each of the projections was covered with a photocurable resin with a thickness of less than 1 m, the Raman intensity was decreased.

Although concave portions and convex portions repeated at the predetermined pitch were present on the surface of each of the three-dimensional shape objects according to Comparative Examples 1 and 3, the ratio AVEₛₜₑₚ/AVEᵢₙₜₑᵣₙₐₗ was more than ½, so that color unevenness occurred and the external appearance quality was impaired. The concave portions and convex portions repeated at the predetermined pitch were not present on the surface of each of the three-dimensional shaped objects according to Comparative Examples 2 and 4, so that unevenness of light reflection occurred on the surface and the external appearance quality was impaired.

According to the present disclosure, it is possible to provide a three-dimensional shaped object with an excellent external appearance quality while suppressing unevenness of light reflection and color unevenness.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-063108, filed Apr. 10, 2024, which is hereby incorporated by reference herein in its entirety.

What is claimed is:

1. A three-dimensional shaped object comprising:
a layered portion obtained by layering a plurality of resin layers,
wherein the three-dimensional shaped object contains a number of inorganic particles,
wherein a plurality of inorganic particles among the number of inorganic particles is dispersed into the layered portion, and
wherein a layered and shaped surface shaped by each of the plurality of resin layers in the layered portion includes a projection formed of a resin film covering some of the number of inorganic particles, the projection corresponding to a shape of the some of the number of inorganic particles.

2. The three-dimensional shaped object according to claim 1, wherein a surface of the some of the number of inorganic particles includes a portion being in contact with a recess in any one of the plurality of resin layers, and a portion being in contact with the resin film.

3. The three-dimensional shaped object according to claim 1, wherein the resin film continuously covers the plurality of resin layers.

4. The three-dimensional shaped object according to claim 1, wherein the resin film is formed of a photocurable resin.

5. The three-dimensional shaped object according to claim 4, wherein the resin film is formed of a photocurable resin identical to a photocurable resin of the resin layer.

6. The three-dimensional shaped object according to claim 1, wherein the resin film has a thickness of less than 1 km.

7. The three-dimensional shaped object according to claim 1, wherein an average value of five Raman measurement intensities in descending order of the some of the inorganic particles is ½ or less of an average value of five Raman measurement intensities in descending order of the inorganic particles located within the layered portion.

8. The three-dimensional shaped object according to claim 1, wherein an average particle size of the inorganic particles is 3 μm or more and 25 m or less.

9. The three-dimensional shaped object according to claim 1, wherein the layered and shaped surface has a shape in which concave portions and convex portions are repeated in a direction in which the plurality of resin layers is layered at a pitch corresponding to a thickness of each of the plurality of resin layers.

10. The three-dimensional shaped object according to claim 9, wherein a pitch of the concave portions and convex portions is 30 μm or more and 150 m or less.

11. The three-dimensional shaped object according to claim 9, wherein a difference in height of the concave portions and convex portions is 1 μm or more and 30 m or less.

12. The three-dimensional shaped object according to claim 1, wherein the number of inorganic particles comprise a flame retardant.

13. The three-dimensional shaped object according to claim 12, wherein the flame retardant is a phosphate flame retardant.

14. The three-dimensional shaped object according to claim 1, wherein the resin layers contain a colorant.

15. The three-dimensional shaped object according to claim 14, wherein the colorant is a carbon black.

16. A manufacturing method of a three-dimensional shaped object using stereolithography, the manufacturing method comprising:
forming a layered portion by repeatedly performing the following a plurality of times: supplying a photocurable resin composition including at least a photopolymerizable compound, a photopolymerization initiator, and a number of inorganic particles in a layered form; and curing the photocurable resin composition in the layered form by irradiating the photocurable resin composition with an activation energy beam;
processing the layered portion using a treatment liquid including a polymerizable compound and a polymerization initiator; and
performing a curing process on the treatment liquid adhering to the layered portion.

17. The manufacturing method of the three-dimensional shaped object according to claim 16, wherein the treatment liquid includes an alcohol organic solvent.

18. The manufacturing method of the three-dimensional shaped object according to claim 17, wherein the alcohol organic solvent is a primary alcohol.

19. The manufacturing method of the three-dimensional shaped object according to claim 18, wherein the primary alcohol is an ethyl alcohol.

20. The manufacturing method of the three-dimensional shaped object according to claim 16, wherein a content of the polymerizable compound in the treatment liquid is 5 mass % or more and 50 mass % or less.

21. The manufacturing method of the three-dimensional shaped object according to claim 16, wherein the polymerizable compound is a photopolymerizable compound.

22. The manufacturing method of the three-dimensional shaped object according to claim 21, wherein the photopolymerizable compound included in the treatment liquid is identical to the photopolymerizable compound included in the photocurable resin composition.

23. A treatment liquid for stereolithography, comprising:
a polymerizable compound;
a polymerization initiator; and
an alcohol organic solvent,
wherein a content of the polymerizable compound is 5 mass % or more and 50 mass % or less.

24. The treatment liquid according to claim 23, wherein the polymerizable compound is a photopolymerizable compound.
